(19) United States
(12) Patent Application Publication
(10) Pub. No.: US 2013/0140111 A1
(43) Pub. Date: Jun. 6, 2013

(54) Safety ladder warning device

(71) Applicant: Kishor Chandra Desai, Winter Park, FL (US)

(72) Inventor: Kishor Chandra Desai, Winter Park, FL (US)

(21) Appl. No.: 13/373,813

(22) Filed: Dec. 1, 2011

(51) Int. Cl. E06C 7/00

(52) U.S. Cl. 182/129

(57) ABSTRACT

The present invention relates to the user warning device embedded in a step ladder that is suited for craftsmen or workmen or for the ladders used in homes to change a bulb or climbing in the attic and the same technology could be adopted in the extension ladders as well. However, it is not about how safe the ladder is, but it is about embedded “Safety Feature” within the “Safety Ladder” and how it warns the user and prevents the accidents that occur, due to human factor in using these “So Called Safety Ladders”. The warnings are both audio and visual.

### CROSS REFERENCE TO RELATED APPLICATIONS

None

### FEDERALLY SPONSORED RESEARCH

None

### SEQUENCE LISTING

Not Applicable

### FIELD OF THE INVENTION

The present invention relates to the user warning device embedded in a step ladder that is suited for craftsmen or workmen or for the ladders used in homes to change a bulb or climbing in the attic and the same technology could be adopted in the extension ladders as well. However, it is not about how safe the ladder is, but it is about embedded safety feature within the safety ladder and how it warns the user and prevents the accidents that occur, due to human factor in using these “So Called Safety Ladders”. The warnings are both audio and visual.

### BACKGROUND OF THE INVENTION

Step ladders are free-standing ladders that can be erected without support from a wall. A step ladder consists of a step frame which is pivotally attached to a support frame. The step frame includes a number of rungs, or steps. Steps are climbing support with “walking surfaces” typically 3.25 inch deep or more, while rungs have less deep “walking surfaces”, between 1-2 inches. For the purpose of this application steps and step ladder will respectively mean steps or rungs and step ladder or rung ladder. The step and support frames are connected by some locking mechanism that prevents the step ladder from collapsing.

Step ladders have definite advantages as they are lightweight, commonly made from aluminum, and easy to erect due to the uncomplicated locking mechanism. Another advantage with the step ladder is that it is free standing and can be erected in the middle of a room to hammer a nail in the wall or to change a bulb.

Step ladders are popular with craftsmen, such as painters and electricians, to mention a few and they often bring with them the step ladders when visiting customers or construction sites. Numerous patents are issued for step ladders, for example U.S. Pat. No. 6,347,687 describes small step ladders without the safety rails. U.S. Pat. Number WO03014516A1 deals with a ladder with narrow steps. Step ladders with more than four steps are considered as more practical by craftsmen, especially to reach higher ceilings in industrial and commercial buildings.

The following patents deal with the issues of safety rails and their transportation to the work site, for example US2004/0007424.A1 describes ladders that are too large to fit in small vans. U.S. Pat. No. 5,163,532 describes a conventional extension ladder with locking hinges of a master/slave variety permitting the locks to be operated from only one side of the ladder.

Locking hinges for folding ladders are disclosed in U.S. Pat. No. 4,824,278 as to how the lock is operated with a lever and U.S. Pat. No. 6,711,780 describes the operation with a knob on the outer of the lock mechanism.

U.S. Pat. No. 4,520,896 describes a foldable ladder including a lower step section connected to a strut. The lower step section is further connected to a lower step section in a lockable pivot located in the connection between the lower step section and the strut. The upper step section may be folded along the lower step section. However, this construction is unstable as the steps in the upper step section are located above the point of support where the lower step section is connected to the strut. Thus, it is dangerous to climb the upper step section.

U.S. Pat. No. 6,651,774 describes a stepladder with a foldable support rail. However, this support rail is not locked in any way when erected, and can thus not give support to a user if he/she accidentally steps backwards. The support rail is evidently only intended to support a tool tray in a high position easily accessible for the user.

Health and Safety regulations in several countries require that ladders for professional use shall support minimum loads. This requirement means that the ladders tend to become heavy and impractical for craftsmen, who need the ladders as light as possible.

One can continue with the narration of the safety ladders and fill hundreds of pages describing the technical aspect of ladder safety but very few or none at all has addressed the human factor involved in the usage of these safety ladders.

When humans use the ladders described above, though ladders have been made much safer over the years, the human minds have not changed much, they have become smarter but we still have dealt with many serious accidents and personal injuries, resulting from the use of the safety ladders and the purpose of this particular invention is to deal with the above situations and prevent such accidents from happening.

The users are in a hurry to climb up and get down the ladder, due to the pressure of work they need to accomplish in given time, or that they are tired and stressed and while coming down the ladder in a hurry and they miss a step or two, or many more and they fall backwards and sustain some serious back injuries, bruised backs, broken ribs, broken arms, broken legs, serious head injuries or paralysis, resulting in blood clots and death in some cases. The purpose of this invention is to warn them that they have climbed certain number of steps and while coming down the ladder, they have this many steps left before they hit the ground. In the following passages will describe the invention briefly and in details with the help of the supporting drawings to make it clear as to how the present invention will function to prevent further accidents from occurring.

### BRIEF SUMMARY OF THE INVENTION

Therefore, it is an object of the present invention to provide a step ladder that is safer and that warns the user that he/she has climbed certain number of steps and will need to come down that many number of steps in order to be safely on the ground.

Another object is to provide a step ladder with the features necessary to warn the user visually, if necessary with a buzzer and talking features or all combined.

Still another object is to provide a ladder with the above mentioned features not only in step ladders but also other kinds of ladders like ceiling ladders as well as extension ladders.

The objects above are achieved in a step ladder as claimed in the appended patent claims. In particular, the inventive step-ladder includes safety features for visual warning, audio and hazard warnings.

The invention will now be described in detail in reference to the appended drawings.

### BRIEF DESCRIPTION OF THE DRAWINGS

FIG. 1 shows the inventive step-ladder mounted,

FIG. 2 shows the two piece step and the trigger that will operate the switch. Outer step (1) and inner part of the step (2) are seen separately in FIG. 2. The trigger (3) and (4) being the spring are seen in the side view. The springs fitted at both ends of the step will keep the inner part of the step up and will not let the trigger depress the switch. The trigger will depress the switch when someone steps on the ladder. The assembled step (5) is also shown in FIG. 2.

FIG. 3 shows the two piece rung of an extension ladder and the trigger that will operate the switch. Outer rung (6) and inner part of the rung (7) are seen separately in FIG. 3. The trigger (8) and (9) being the spring are seen in the side view. The springs fitted at both ends of the rung will keep the inner part of the rung up and will not let the trigger depress the switch. The trigger will depress the switch when someone steps on the ladder. The assembled step (10) is also shown in FIG. 3.

FIG. 4 shows the trigger (11) and the switch (12) and the necessary wire connections (13) as well as the spring (14) in position when assembled.

FIG. 5 shows the step-ladder mounted, visual warnings lit up (15), that the user is on the 5^{th} step of the ladder. It also shows the battery compartment (16) and speakers for the audio system (17). The wiring runs in the support frame (18). The bulb mounted behind the frame is shown in the side detail in FIG. 5.

FIG. 6 shows the uppermost step in details. The battery compartment (16) and speakers (17) and the horizontal warning lights (22) are visible in these drawings.

### DETAILED DESCRIPTION OF THE INVENTION

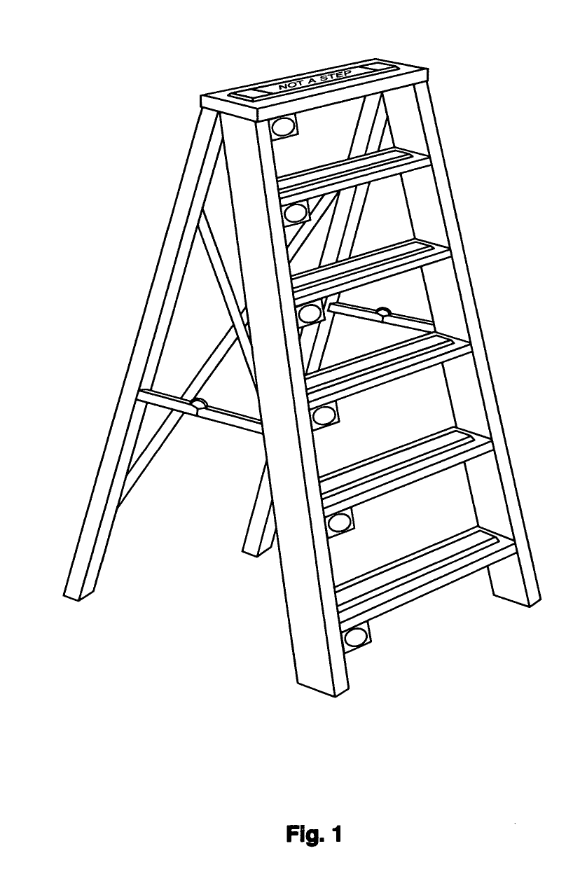

The ladder shown in FIG. 1 is a step frame composed of including a pair of side rails and a number of spaced rungs. The ladder is connected by the hinges at the top with side frame comprised of two side rails and cross supports. The two frames of the ladder are connected together by two folding supports, one on each side in the center. Under each step, on the left (or right) hand side there will be a little framed window (15). The frame will either be made of metal or plastic and the clear window will be made of either non breakable (shatter proof) glass or clear plastic. Behind the frame there will be the housing that will hold a LED or other suitable lighted number. The housing will be held with the frame with tiny screws.

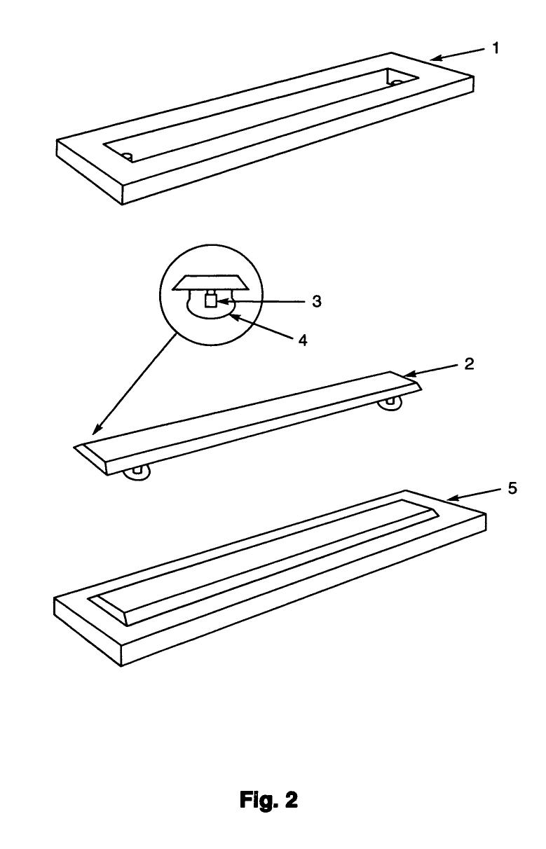

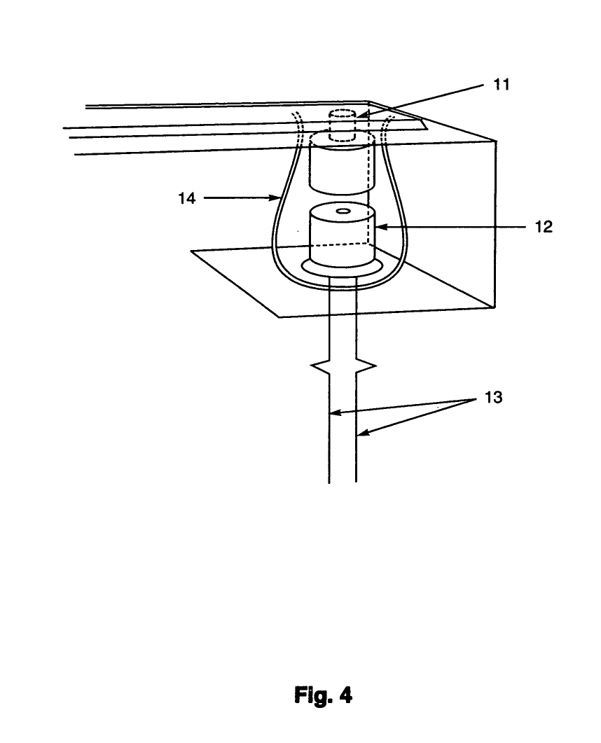

FIG. 2 shows the details of a step or rung made of two pieces. The inner piece (2) is having a tiny metal piece sticking out at the bottom (3) that will activate the switch (12) in (FIG. 4), which is held by the top piece of the rung and there will be spring (4) loaded on each side of the rung that will push the inner piece up and thus the trigger will not operate the switch unless someone steps on the ladder and pushes the inner piece (2) of the step/rung down, to operate the switch.

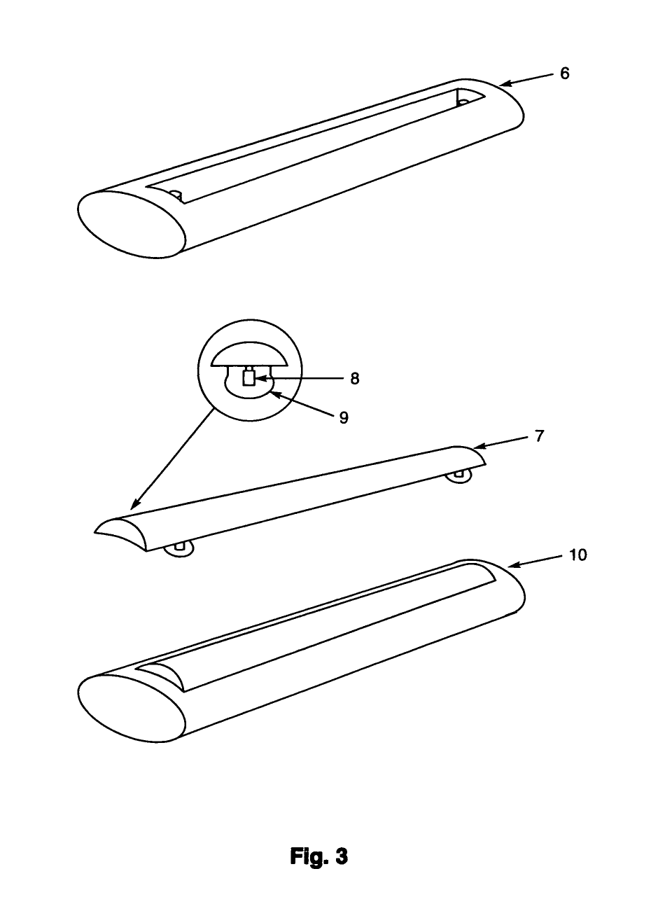

FIG. 3 shows the rung of an extension ladder, which is more oval to round shaped, however, it operates the same way as described in [0024].

FIG. 4 shows the step or rung and switch (12) and trigger (11) all in their respective positions, as assembled. The spring (14) pushing the inner step upwards.

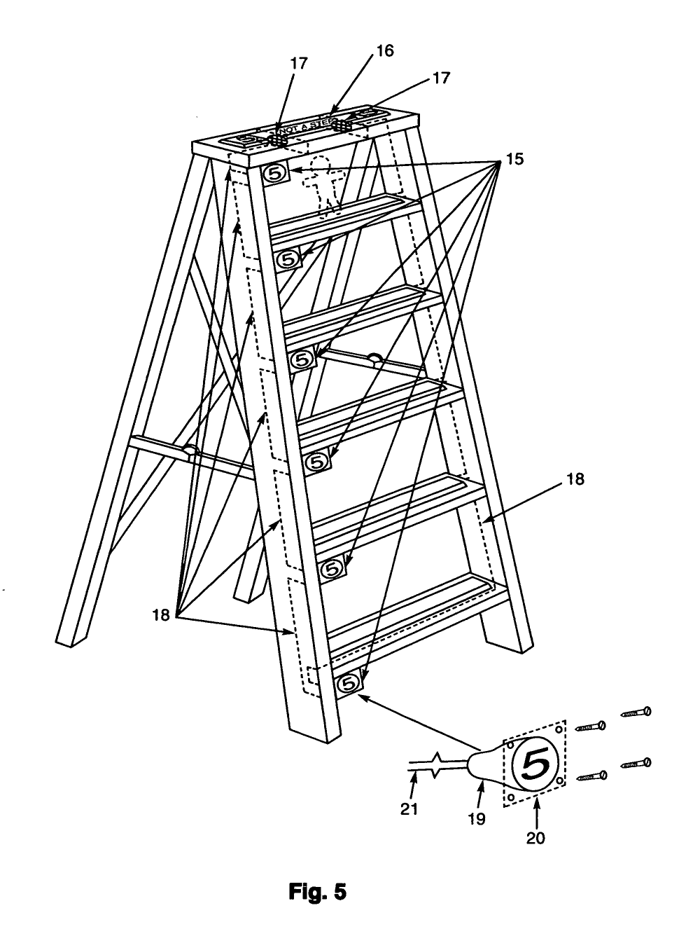

FIG. 5 shows the person on step 5 and all LED or other suitable lights showing number 5, indicating the person has climbed the ladder and is on step number 5.

FIG. 5 also shows the battery compartment (16), from which all LED or other suitable lights will be connected and powered, as well as the audio and hazard warnings. Other electronics will be housed in the same area. The wiring will run alongside the support frames. Besides the battery compartment small speakers (17) will be attached also and they will sound the audio and hazard warnings. FIG. 5 also shows the bulb (19), the frame (20) and the wiring (21) in the side details.

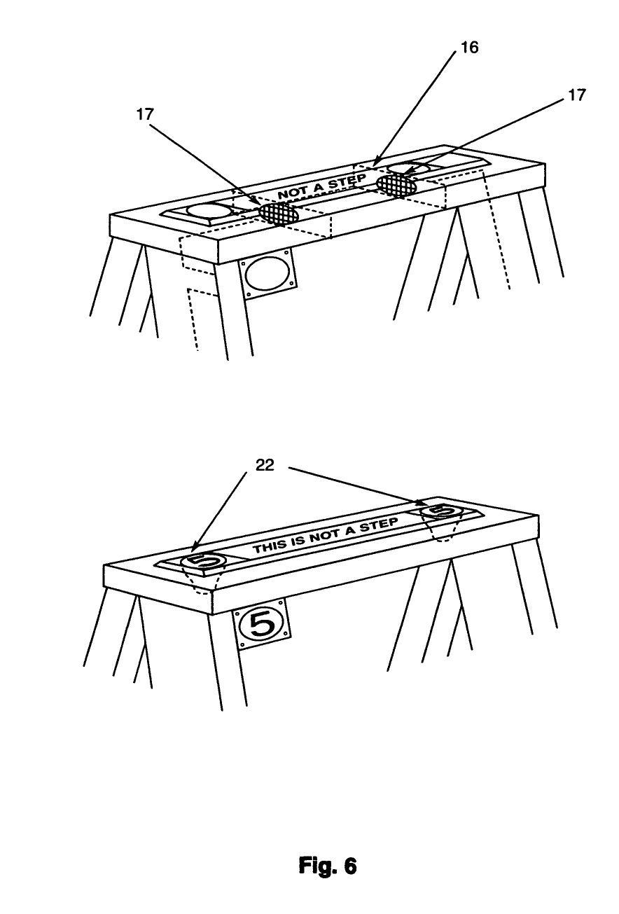

FIG. 6 shows the enlarged view of the uppermost step of the step ladder in details. The battery compartment (16) and the speakers (17) are clearly visible, in this detail. The bottom detail of the same step shows the two lights (22) that will glow when someone is on step 5 or alternatively on the last but one from the uppermost step. Since the person will be above the uppermost step and will not be able to see the vertical warning lights but will be able to see the horizontally mounted visual warning lights.

When the user mounts the free standing ladder or an extension ladder and steps on the first step, the warning system will operate. All LED or other suitable lights will flash number 1, this will be a red light and it will be easier to see it even in bad weather conditions or in dark. When the user climbs the 2^{nd} step, the LED or other suitable light will show number 2, as the climber climbs higher, the numbers will go higher too in an ascending order, for example 3, 4, 5 and so on. The audio system will announce the numbers of steps climbed, for example “Step 1”, “Step 2” and so on. When the person climbing reaches the uppermost step, warning will sound and warn the climber, “This is not a step” and a buzzer will sound warning the person of a potential fall hazard. When the person goes down the ladder, the audio system will count the numbers backwards, for example, “Step 5”, “Step 4” and “Step 3” and so on. When the person reaches the last step, it will announce “Next step ground”. The LED or other suitable lights will show the numbers in a descending order when the user is climbing down, for example 5, 4, 3, 2 and 1.

All the features described in this application may be combined in the ladder or will be available as an additional feature to keep the cost down. The placement of the features and their connections will also be determined by the manufacturing process.

I claim:

1) A safety warning device embedded in the ladder itself that is a visual device.

2) A visual warning device as claimed in (1) and is LED or other suitable light, that lights up the number that corresponds with the number of step climbed in ascending order, when the person is climbing up the ladder.

3) A visual warning device as claimed in (1) and is LED or other suitable light, that lights up the number that corresponds with the number of step while the person is coming down the ladder in a descending order.

4) An audio warning device that is counting the number of step in ascending order, when the user is climbing up the ladder.

5) An audio warning device as claimed in (4) that counts down and announces the step in a descending order when the person is coming down the ladder.

6) An audio warning device that warns the user, when he/she is on the upper-most step, that “This is not a step”.

7) An audio warning device as claimed in (6) that will also sound a buzzer, besides announcing “This is not a step” and warn the person of a potential fall.

8) An audio warning device that warns the user when he/she is climbing down and is on the last step by announcing that the next step will be the ground.

9) A two piece step or rung construction and a trigger and switch synchronization, to operate the warning system embedded in the ladder.
